(19) United States
(12) Patent Application Publication
(10) Pub. No.: US 2010/0318733 A1
(43) Pub. Date: Dec. 16, 2010

(54) Memory system performing refresh operation

(75) Inventors: Huikwon Seo, Hwaseong-si (KR); Hangu Sohn, Suwon-si (KR); Seijin Kim, Seongnam-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/662,948

(22) Filed: May 13, 2010

(30) Foreign Application Priority Data
Jun. 15, 2009 (KR) 10-2009-0052975

(51) Int. Cl. G06F 12/00

(52) U.S. Cl. 711/106; 711/E12.001; 711/104

(57) ABSTRACT

The memory system includes a memory cell array including a plurality of memory sectors and a controller configured to write data in the memory cell array in response to a writing signal. The controller is configured to refresh at least one of the plurality memory sectors when the writing signal is provided.

### CROSS-REFERENCE TO RELATED APPLICATION(S)

This U.S. non-provisional patent application claims priority under 35 U.S.C. §119 of Korean Patent Application No. 10-2009-0052975, filed on Jun. 15, 2009, the entire contents of which are hereby incorporated by reference.

### BACKGROUND

1. Field

Example embodiments of inventive concepts relate to a memory system, for example, to a memory system performing a refresh operation.

2. Description of the Related Art

Recently, memory systems using semiconductor memory devices have increased. A semiconductor memory device may store data and read the stored data when necessary. A semiconductor memory device may be classified into a volatile memory device or a nonvolatile memory device.

A volatile memory device loses its stored data when its power supply is interrupted. A volatile memory device may include SRAM, DRAM, SDRAM or the like. A nonvolatile memory device maintains its stored data even when its power supply is interrupted. A nonvolatile memory device may include ROM, PROM, EPROM, EEPROM, flash memory device, PRAM, MRAM, RRAM, FRAM or the like.

### SUMMARY

According to example embodiments of inventive concepts, a memory system includes a memory cell array including a plurality of memory sectors and a controller configured to write data in the memory cell array in response to a writing signal. The controller is configured to refresh at least one of the plurality memory sectors when the writing signal is provided.

### BRIEF DESCRIPTION OF THE DRAWINGS

The accompanying drawings are included to provide a further understanding of example embodiments of inventive concepts, and are incorporated in and constitute a part of this specification. The drawings illustrate example embodiments of inventive concepts and, together with the description, serve to explain principles of inventive concepts. In the figures:

FIG. 1 is a block diagram illustrating a memory system in accordance with example embodiments of inventive concepts;

FIG. 2 is a block diagram illustrating a memory cell array illustrated in FIG. 1;

FIG. 3 is a flow chart illustrating a refresh operation of the memory system illustrated in FIG. 1;

FIG. 4 is another block diagram illustrating a memory system in accordance with example embodiments of inventive concepts;

FIG. 5 is a flow chart illustrating a refresh operation of the memory system illustrated in FIG. 4;

FIG. 6 is still another block diagram illustrating a memory system in accordance with example embodiments of inventive concepts;

FIG. 7 is yet another block diagram illustrating a memory system in accordance with example embodiments of inventive concepts; and

FIG. 8 is a block diagram illustrating a computing system including a memory system in accordance with example embodiments of inventive concepts.

### DETAILED DESCRIPTION

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures. The figures are intended to depict example embodiments and should not be interpreted to limit the intended scope of the claims. The accompanying figures are not to be considered as drawn to scale unless explicitly noted.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,” “includes” and/or “including”, when used herein, specify the presence of stated features, integers, steps, operations, elements, and/or components, but do not preclude the presence or addition of one or more other features, integers, steps, operations, elements, components, and/or groups thereof. In this specification, the term “and/or” picks out each individual item as well as all combinations of them.

Example embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

It should also be noted that in some alternative implementations, the functions/acts noted may occur out of the order noted in the FIGS. For example, two FIGS. shown in succession may in fact be executed substantially concurrently or may sometimes be executed in the reverse order, depending upon the functionality/acts involved.

When it is determined that a detailed description related to a related known function or configuration may make the purpose of example embodiments unnecessarily ambiguous, the detailed description thereof will be omitted. Also, terms used herein are defined to appropriately describe example embodiments and thus may be changed depending on a user, the intent of an operator, or a custom. Accordingly, the terms must be defined based on the following overall description within this specification.

Example embodiments of inventive concepts will be described below in more detail with reference to the accompanying drawings. Example embodiments of inventive concepts may, however, be embodied in different forms and should not be constructed as limited to the example embodiments set forth herein. Rather, these example embodiments are provided so that this disclosure will be thorough and complete, and will fully convey the scope of inventive concepts to those skilled in the art. Like numbers refer to like elements throughout.

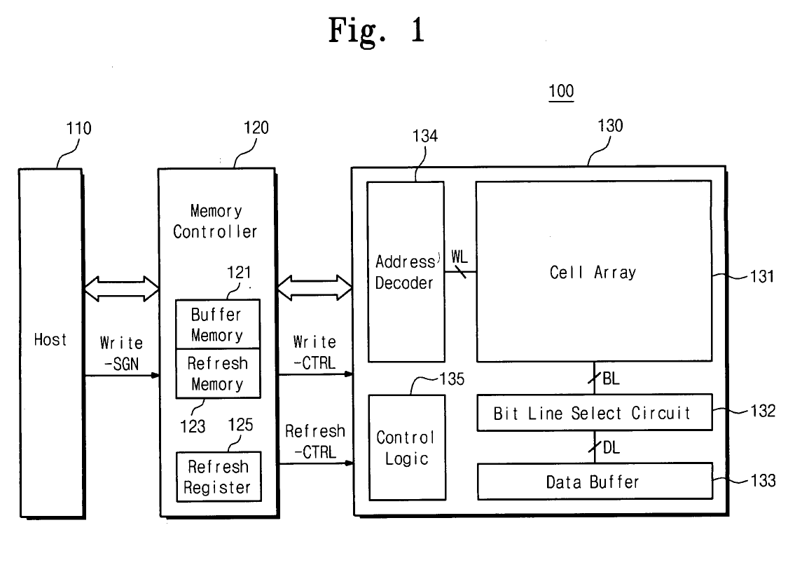

FIG. 1 is a block diagram illustrating a memory system in accordance with example embodiments of inventive concepts.

Referring to FIG. 1, a memory system 100 in accordance with example embodiments of inventive concepts includes a host 110, a memory controller 120 and a nonvolatile memory device 130.

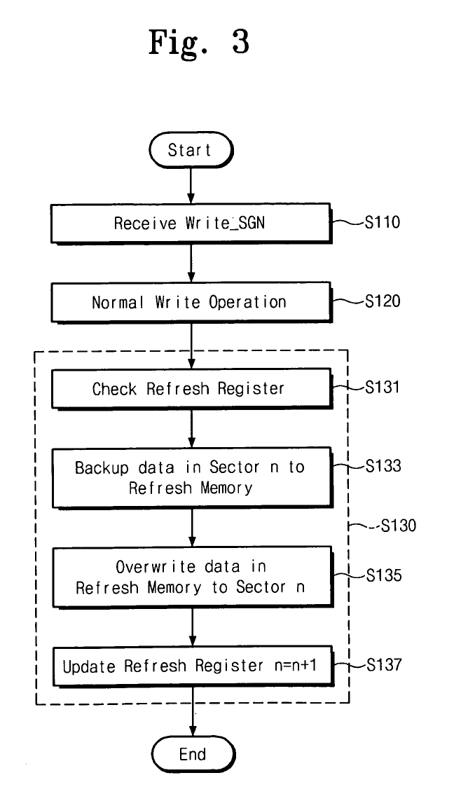

The host 110 is connected to the memory controller 120. The host 110 receives data stored in the nonvolatile memory device 130 through the memory controller 120. Also, the host 110 transmits data to the nonvolatile memory device 130 through the memory controller 120. In this case, the host 110 generates a, data writing command (write_SGN), which will be described in further detail in FIG. 3.

The memory controller 120 is connected to the host 110 and the nonvolatile memory device 130. The memory controller 120 includes a buffer memory 121, a refresh memory 123 and a refresh register 125.

The buffer memory 121 temporally stores data to be written in the nonvolatile memory device 130. For example, the buffer memory 121 receives data from the host 110. Data transmitted to the buffer memory 121 is written in a memory cell array 131 through a data buffer 133.

Also, the buffer memory 121 temporally stores data read from the nonvolatile memory device 130. That is, the data buffer 133 transmits data read from the memory cell array 131 to the buffer memory 121. The buffer memory 121 transmits data transmitted from the data buffer 133 to the host 110.

The refresh memory 123 temporally stores data read from the memory cell array 131. According to example embodiments of inventive concepts, the refresh memory 123 may temporally store data stored in a sector of the memory cell array 131.

The refresh register 125 stores refresh information of the memory cell array 131. According to example embodiments of inventive concepts, the refresh register 125 may store location information on a sector where a refresh operation is performed. The refresh memory 123 and the refresh register 125 may perform a refresh operation.

The memory controller 120 generates a writing control signal (write_CTRL) for transmitting data transmitted from the host 110 to the nonvolatile memory device 130. Also, the memory controller 120 generates a refresh control signal (refresh_CTRL) for refreshing data stored in a target sector. Here, the target sector means the sector in which a refresh operation is performed.

The nonvolatile memory device 130 includes the memory cell array 131, a bit line select circuit 132, the data buffer 133, an address decoder 134 and control logic 135.

The memory cell array 131 includes a plurality of memory cells to store data. The memory cell array 131 includes a number of sectors. In this case, the number of sectors may be determined by a disturb characteristic of the memory cell. The bit line select circuit 132 is connected to the memory cell array 131 through bit lines (BL). The bit line select circuit 132 selects a bit line in response to a control of the address decoder 134. The bit line select circuit 132 selects a bit line corresponding to a sector of the memory cell array 131.

The data buffer 133 is connected to the bit line select circuit 132 through data lines (DL). The data buffer 133 stores data transmitted from the memory controller 120 in the memory cell array 131. The data buffer 133 also transmits data read from the memory cell array 131 to the memory controller 120.

The address decoder 134 is connected to the memory cell array 131 through word lines. The address decoder 134 includes a row decoder (not illustrated) and a column decoder (not illustrated). The row decoder receives a row address (RA) from the memory controller 120. The row decoder decodes a row address (RA) and selects a word line (WL) of the memory cell array 131 in response to the decoded row address. The column decoder receives a column address (CA) from the memory controller 120. The column decoder decodes a column address (CA) and controls the bit line select circuit 132 in response to the decoded column address.

The address decoder 134 receives an address from the memory controller 120 to select a target sector.

The control logic 135 receives a control signal (CTRL) from the outside or externally. The control logic 135 controls every operation of the nonvolatile memory device 100 in response to the control signal (CTRL).

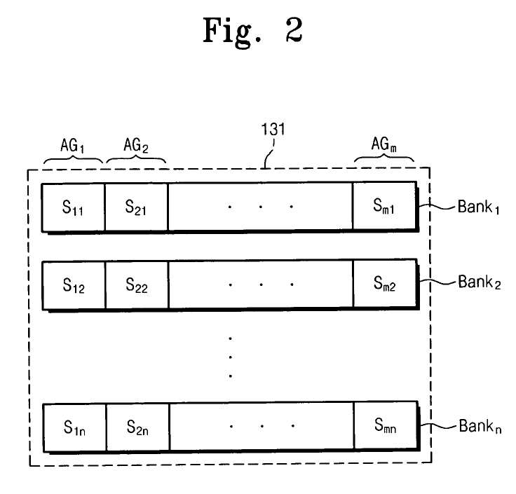

FIG. 2 is a block diagram illustrating a memory cell array illustrated in FIG. 1.

Referring to FIG. 2, the memory cell array 131 includes a plurality of sectors. Each of the sectors includes a plurality of memory cells to store data.

For example the memory cell array 131 may include a plurality of address groups (AG). In this case, collection of memory cells corresponding to the bit line selected by the bit line select circuit 132 may be called an address group (AG). It is assumed that the memory cell array 131 includes a plurality of banks. In this case, collection of memory cells corresponding to the word line selected by the address decoder 134 may be called a bank (BANK). Collections of memory cells corresponding to each of the address groups (AG) of each of the banks (BANK) may be called a sector. For instance, the collection of memory cells corresponding to a first address group (AGI) and a first bank (BANK) is called a sector (S11). It is assumed that a memory cell array includes ‘m×n’ number of sectors.

The memory cell array 131 includes a plurality of sectors. In this case, the number of sectors may be determined by a disturb characteristic of a memory cell in order to guarantee or improve a likelihood of a refresh operation of at least one time before data stored in a memory cell of the memory cell array 131 is changed. This allows for an improvement of a data-retention characteristic and as a result, reliability of the nonvolatile memory device 100 will be improved.

For example, the memory cell array 131 may include a plurality of phase change memory cells (PRAM). The phase change memory cell (PRAM) has a resistance which is variable according to an applied temperature. For instance, the phase change memory cells include chalcogen compound of which a resistance is variable according to an applied temperature.

If a temperature higher than a melting temperature of a chalcogen compound is applied to the chalcogen compound for a short time, the chalcogen compound transits to an amorphous state. If a temperature lower than a melting temperature of the chalcogen compound is applied to the chalcogen compound for a long time, the chalcogen compound transits to a crystalline state. A resistance of the chalcogen compound of a crystalline state is lower than a resistance of the chalcogen compound of an amorphous state. For example, a phase change memory device may store data by transiting the chalcogen compound to a crystalline state or an amorphous state. Also, when a portion of an amorphous state is in the crystalline state, a resistance of the chalcogen compound becomes high.

The chalcogen compound transits to a crystalline state or an amorphous state by heat generated when a current flows through a memory cell. For example, if a data writing operation is performed, a write current is provided to a phase change memory cell through a bit line. Since a joule of heat generated by a write current is in proportion to the square of a write current, enough heat to transit a state of chalcogen compound is provided to a phase change memory cell.

In this case, memory cells adjacent to the memory cell (hereinafter, a target memory cell) in which data is written may be affected by a joule of heat. For example, the target memory cell and adjacent memory cells can be connected to a common bit line through an upper electrode or a lower electrode. If a write current is applied to the target memory cell, a joule of heat will be generated in the target memory cell. In this case, the joule of heat may be transmitted to memory cells adjacent to the target memory cell through a bit line. This means that resistances of adjacent memory cells may be changed. Also, this means that reliability of data stored in a phase change memory cell may be degraded.

The memory system in accordance with example embodiments of inventive concepts may improve reliability of memory cells adjacent to the target memory cell by performing a ordered refresh operation on all the sectors of the memory cell array. For example, the memory system may perform a refresh operation on each sector whenever data a writing command (write_SGN) is provided from the host 110.

For a brief description, as an illustration, in the case that 1000 data writing operations are consecutively performed on the same memory cell, assume that chalcogen compound of an adjacent phase change memory cell transits from a crystalline state to an amorphous state. This may be an example of a worst case scenario and means that in the case that 1000 data writing operations are consecutively performed on the same memory cell, data stored in an adjacent memory cell may be changed.

In this case, the memory cell may include 1000 sectors. For example, the memory cell array 131 may include 1000 sectors. When a data writing command is provided from the host, one sector is refreshed in response to one data writing command.

Also, a refresh operation is performed by according to an order. As an illustration, a refresh operation may be sequentially performed but is not limited to thereto. Assuming that a refresh operation is sequentially performed, a refresh operation is first performed on a sector (S₁₁). After that, when a next data writing request is provided, a refresh operation is performed on a sector (S₂₁).

According to the method, when 1000 writing commands are provided, a refresh operation is sequentially performed on 1000 sectors. Thus, when 1000 data writing commands are provided, a refresh operation is performed on all the phase change memory cells of the memory cell array 131.

According to the method described above, a data retention characteristic of a memory cell may be improved. This is because at least one refresh operation is performed on all the memory cells. The description described above is only an illustration. For example, memory cells of the memory cell array 131 may be a flash memory. Memory cells of the memory cell array 131 may be a ferroelectric random access memory (FRAM). Memory cells of the memory cell array 131 may be a magnetroresistive random access memory (MRAM). Memory cells of the memory cell array 131 may be a resistive random access memory (RRAM).

The number of sectors of the memory cell array 131 may be set up by another standard as well. The number of sectors may be set up ahead by an external condition. For example, the number of sectors may be set up by durability of the target memory cell.

A refresh operation may be performed by a reprogram method. According to a reprogram method, data read from a target sector is stored in memory cells of the target sector.

FIG. 3 is a flow chart illustrating a refresh operation of the memory system illustrated in FIG. 1.

In FIG. 3, referring to FIGS. 1 and 2, a refresh operation in accordance with example embodiments of inventive concepts will be described in detail. For a brief description, assume that after a normal write operation is performed, a refresh operation is performed. Also, assume that a refresh operation is sequentially performed.

In a step S110, a data writing command (write_SGN) is provided from the host 110. The memory controller 120 generates a writing control signal (write_CTRL) in response to the data writing command (write_SGN). This is for performing a normal writing operation and will be described in detail in a step S120.

The memory controller 120 generates a refresh control signal (refresh_CTRL) in response to the data writing command (write_SGN). This is for performing a normal refresh operation and will be described in detail in a step S130.

In step S120, a normal write operation is performed. The memory controller 120 receives data from the host 110. The data transmitted from the host 110 is temporally stored in the buffer memory 121. The memory controller 120 transmits a writing control signal (write_CTRL) for writing the data stored in the buffer memory 121 to the memory cell array 131 to the nonvolatile memory device 130.

The control logic 135 controls the nonvolatile memory device 130 in response to the writing control signal (write_CTRL) so that the data stored in the buffer memory 121 is stored in the memory cell array 131. For example, the control logic 135 controls the nonvolatile memory device 130 so that the data stored in the buffer memory 121 is stored in the memory cell array 131.

In step S130, a refresh operation is performed. For a brief description, assume that a refresh operation is sequentially performed and a refresh operation on a sector (S₁₁) is completed. The target sector is the sector (S₂₁) and a refresh operation is performed on the target sector.

In a step of S131, location information on a sector where a refresh operation is completed is checked, the location information being stored in the refresh register 125. For example, the memory controller 120 checks an address of a sector (S₁₁) stored in the refresh register 125. The memory controller 120 generates a refresh control signal (refresh_CTRL) so that a refresh operation is performed on the target sector (S₂₁), which is a next sector of the sector (S₁₁). In this case, the refresh control signal (refresh_CTRL) includes an address signal (not illustrated) with respect to the target sector (S₂₁).

In a step of S133, data stored in the target sector is temporally stored in the refresh memory 123. For example, the control logic 135 receives the refresh control signal (refresh_CTRL) from the memory controller 120. In this case, the control logic 135 controls the nonvolatile memory device 130 so as to perform a read operation for a refresh operation.

For example, the control logic 135 controls the address decoder 134 to read data stored in the target sector (S₂₁). The address decoder 135 selects the target sector (S₂₁) in response to the control logic 135 and an address signal (not illustrated). Data stored in the target sector (S₂₁) is stored in the refresh memory 123 through the data buffer 133.

In a step of S135, the data stored in the refresh memory 123 is stored in the target sector (S₂₁) again. For example, the memory controller 120 generates the refresh control signal (refresh_CTRL) so that the data stored in the refresh memory 123 is stored in the target sector (S₂₁) again. In this case, the refresh control signal (refresh_CTRL) includes a sub writing control signal (sub_write_CTRL) to write data in the target sector (S₂₁).

The control logic 135 controls the nonvolatile memory device 130 in response to the refresh control signal (refresh_CTRL) so that the data stored in the refresh memory 123 is stored in the target sector (S₂₁).

In a step S137, location information on a sector where a refresh operation is completed is renewed, the location information being stored in the refresh register 370. For example, when a refresh operation with respect to the target sector (S₂₁) is completed, address information on the target sector (S₂₁) is stored in the refresh register 370.

After that, assuming that a data writing command is provide from the host 110, a refresh operation is performed again by the steps described above. A target sector becomes a sector (S₃₁), which is a next sector of the sector (S₂₁).

A refresh operation may be performed on sectors included in the memory cell array 131 by the method described above. Referring to FIGS. 1 through 3, when data writing commands of m×n number of times are provided from the host, all the sectors of the memory cell array 131 are refreshed one time according to an order. Thus, a data retention characteristic of the memory cell array 131 may be improved.

If a refresh operation is performed on all the sectors of the memory cell array 131, a refresh operation is sequentially performed on the first sector again. For example, in the case that a data writing command is provided from the host after a refresh operation is performed on a sector (Sₘₙ), a refresh operation is performed on the sector (S₁₁).

The refresh operation described above is an illustration. For instance, a refresh operation may be performed after a normal writing operation is performed. Also, location information on the target sector stored in the refresh register may be renewed after data stored in the target sector is stored in the refresh register.

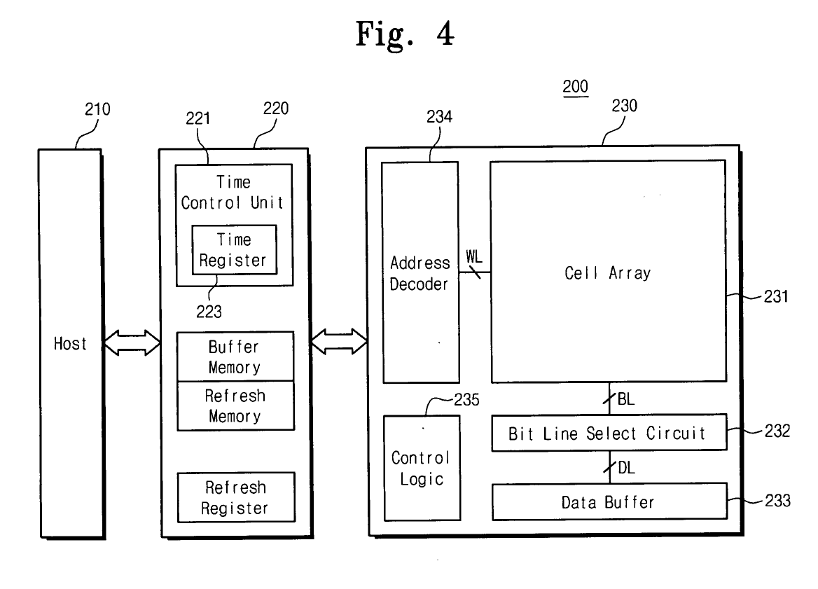

FIG. 4 is another block diagram illustrating a memory system in accordance with example embodiments of inventive concepts.

Referring to FIG. 4, a memory system 200 includes a host 210, a memory controller 220 and a nonvolatile memory device 230. The memory controller 220 includes a time control unit 221 and the time control unit 221 includes a time register 223.

The time control unit 221 controls the memory system 200 so that a refresh operation is performed when the reference time elapses. The time register 223 controls time information of when a refresh operation with respect to all the sectors of a memory cell array 231 is completed.

An operation of the memory stem 200 of FIG. 4 is similar to the operation of the memory system 100 of FIG. 1, except for the time control unit 221. Hereinafter, a description will be focused on the time control unit 221. For a brief description, assume that a refresh operation is sequentially performed.

Referring to FIG. 2, a refresh operation is sequentially performed on all the sectors. When a refresh operation with respect to a sector (Sₘₙ) is completed, a refresh operation of one cycle with respect to all the sectors of the memory cell array is performed.

A time that a refresh operation of one cycle is completed is referred to as a refresh cycle completion time. The time register 223 stores refresh cycle completion time information. For example, the time register 223 stores time information of when a refresh operation with respect to a sector (Sₘₙ) is completed.

The time control unit 221 may be configured to store the present time information when the memory system 200 powers up. The present time information is provided from the outside or externally (e.g., a host, an external timer). The time control unit 221 may be configured to store the reference time information. Here, the reference time represents a quantity (hour) of time such as one month, two month and so on. For example, the time control unit 221 may further include registers which can store the present time information and the reference time information.

The time control unit 221 compares completion time information of a refresh cycle with the present time information to calculate a time difference. The time control unit 221 compares the calculated time difference with the reference time information to determine whether performing a refresh operation or not. For example, assume that the reference time information is two months. If a difference between refresh cycle completion time information and the present time information is less than two month, a refresh operation is not performed. The time control unit 221 compares refresh cycle completion time information with the present time information and if a difference between refresh cycle completion time information and the present time information is greater than the reference time, it controls the memory system 200 so that a refresh operation is performed.

If a difference between refresh cycle completion time information and the present time information is greater than the reference time, a refresh operation is performed. For example, if a difference between refresh cycle completion time information and the present time information is greater than the reference time, a refresh operation with respect to sectors of the memory cell array 231 is respectively performed whenever a data writing request is provided from the host. The refresh operation may be similar to the refresh operations described with respect to FIG. 1, so a detailed description is omitted. A refresh operation will continue until a refresh operation of one cycle is completed.

When a refresh operation of one cycle is completed, the time register 223 stores new refresh cycle completion time information. In this case, the time control unit 221 compares the new refresh cycle completion time information with the reference time information to determine whether performing a refresh operation or not.

According to the method described above, a refresh operation may be performed at a regular time interval. That is, a refresh operation with respect to one cycle is performed at a regular time interval. This means that performance of a memory system may be improved.

The reference time may be variously defined. For example, the reference time is set to be shorter than a guarantee time of memory cells of the memory cell array. Here, the guarantee time means a time that a data retention characteristic stored in a memory cell is not changed by a disturbance. For another example, the reference time is set by considering the guarantee time of memory cells of the memory cell array and the number of memory sectors. As the number of memory sectors increases, the reference time may be set to be gradually shorten.

The time control unit 221 is merely one of many ways for carrying out the above operation according to example embodiments of inventive concepts. For example, the control logic 235 may be configured to store the present time. The nonvolatile memory device 230 may also be configured to store refresh cycle completion time information.

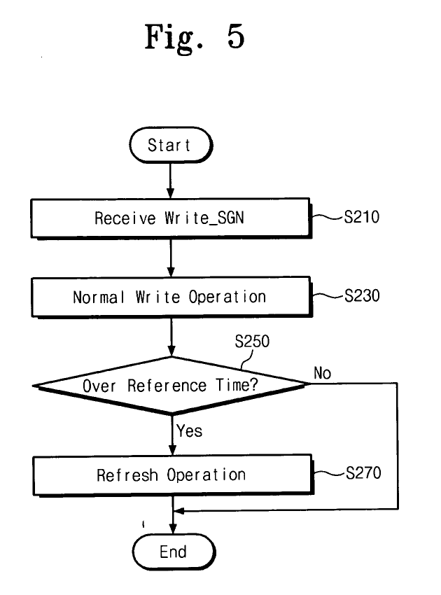

FIG. 5 is a flow chart illustrating a refresh operation of the memory system illustrated in FIG. 4.

In a step S210, a data writing command (write_SGN) is transmitted from the host 210. Since an operation of the memory system 200 in the step S210 is similar to the operation of the operation of the memory system 100 in the step S110, a detailed description is omitted.

In a step S230, a normal writing operation is performed. Since an operation of the memory system 200 in the step S230 is identical to the step S120 of FIG. 3, a detailed description is omitted.

In a step S250, whether a difference between the refresh cycle completion time and the present time is greater than the reference time or not is judged. In the case that a refresh operation of one cycle is completed, refresh cycle completion time information is stored in the time register 223. The present time information of when the memory system 200 powers up is stored in the time control unit 221.

The time control unit 221 calculates a difference between the refresh cycle completion time and the present time. If the calculated time is greater than the reference time, a refresh operation is performed (S270). Since the step S270 in which a refresh operation is performed is identical or similar to the step S130 of FIG. 3, a detailed description is omitted. If the calculated time is smaller than the reference time, a refresh operation is not performed.

According to the method described above, a refresh operation may be performed at a regular time interval. For example, a refresh operation with respect to one cycle is performed at a regular time interval. This means that performance of a memory system may be improved.

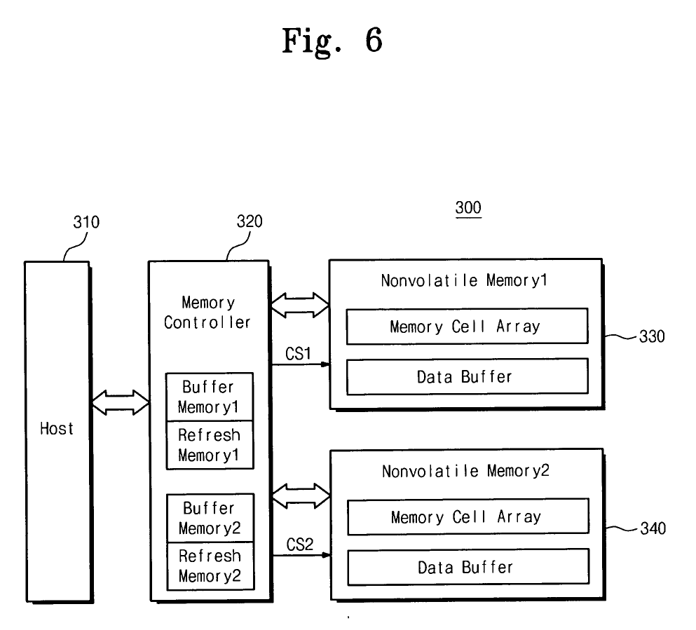

FIG. 6 is still another block diagram illustrating a memory system in accordance with example embodiments of inventive concepts.

Referring to FIG. 6, a memory system 300 includes a host 310, a memory controller 320, a first nonvolatile memory device 330 and a second nonvolatile memory device 340. The memory controller 320 includes first and second buffer memories. The memory controller 320 includes first and second refresh memories.

The first and second buffer memories store data in the first and second nonvolatile memory devices 330 and 340 respectively. The first and second buffer memories perform refresh operations on the first and second nonvolatile memory devices 330 and 340 respectively.

The first and second nonvolatile memory devices 330 and 340 include a memory cell array and a data buffer. An illustration and structures of the first and second nonvolatile memory devices 330 and 340 may be similar to those described in FIGS. 1 and 4.

The first and second nonvolatile memory devices 330 and 340 are selected by first and second chip select signals (CS1, CS2) respectively. The first nonvolatile memory device 330 is selected by the first chip select signal (CS1). The second nonvolatile memory device 340 is selected by the second chip select signal (CS2).

Referring to FIG. 6, a process of performing a refresh operation in the memory system 300 is described. For a brief description, assume that a refresh operation with respect to the first nonvolatile memory device 330 is performed first, and then a refresh operation with respect to the second nonvolatile memory device 340 is performed.

In the case that a data writing command (write_SGN) is provided from the host 310, data transmitted from the host 310 is stored in the first buffer memory. After that, the first nonvolatile memory device 330 is activated by the first chip select signal (CS1). In this case, data stored in the first memory buffer is stored in the memory cell array of the first nonvolatile memory device 330. Data stored in a sector of the first nonvolatile memory device 330 is refreshed using the first refresh memory. Since this operation may be similar to the method described in FIGS. 1 and 4, a detailed description is omitted.

After that, if a data writing request is provide from the host 310 again, data transmitted from the host 310 is stored in the second buffer memory. After that, the second nonvolatile memory device 340 is activated by the second chip select signal (CS2). The refresh operation of the second nonvolatile memory device 340 may be identical or similar to the refresh operation of the first nonvolatile memory device 330. The refresh operation of the second nonvolatile memory device 340 is performed using only the second refresh memory.

According to the method described above, two nonvolatile memory devices may be controlled by one memory controller 320. However, example embodiments of inventive concepts are not limited to the above and may include plurality of nonvolatile memory devices controlled by one memory controller.

A structure of the memory controller 320 of FIG. 6 is not limited to the above, according to example embodiments of inventive concepts. For example, the memory controller 320 of FIG. 6 may include a time control unit. For instance, a structure of the memory controller 320 of FIG. 6 may be similar to a structure of the memory controller 220 of FIG. 4.

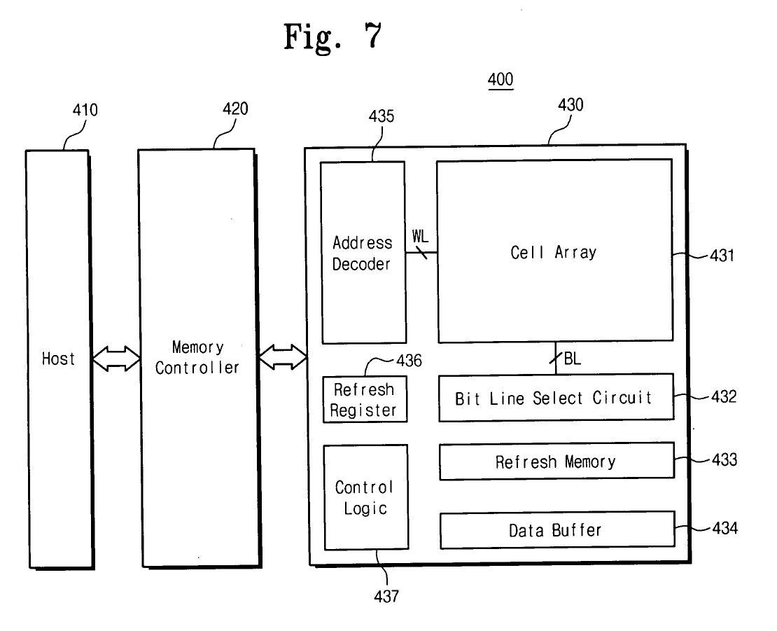

FIG. 7 is yet another block diagram illustrating a memory system in accordance with example embodiments of inventive concepts.

Referring to FIG. 7, a memory system 400 includes a host 410, a memory controller 420 and a nonvolatile memory device 430. The nonvolatile memory device 430 includes a memory cell array 431, a bit line select circuit 432, a refresh memory 433, a data buffer 434, an address decoder 435, a refresh register 436 and control logic 437.

An operation of the memory system 400 of FIG. 7 may be similar to the operation of the memory system 100 of FIG. 1. Hereinafter, a description is mainly focused on an operation difference between the memory system 400 of FIG. 7 and the memory system 100 of FIG. 1. For a brief description, assume that a refresh operation is sequentially performed. Referring to FIG. 2, it is assumed that a refresh operation is sequentially performed from a sector (S₁₁) to sector (Sₘₙ).

When a data writing command (write_SGN) is provided from the host 410, the memory controller 420 transmits a writing control signal (write_CTRL) to the nonvolatile memory device 430. The control logic 437 stores data transmitted from the host 410 in the memory cell array 431 in response to the writing control signal (write_CTRL). Since this process is described in FIGS. 1 and 3 in detail, a detailed description is omitted.

Also, the control logic 437 controls the nonvolatile memory device 430 in response to the writing control signal (write_CTRL) to perform a refresh operation on a target sector (S₁₁). For example, the control logic 437 controls the nonvolatile memory device 430 to temporally store data stored in the target sector (S₁₁) in the refresh memory 433. The data stored in the refresh memory 433 is stored in the target sector (S₁₁) again. The control logic 437 controls the nonvolatile memory device 430 to store the data stored in the refresh memory 433 in the target sector (S₁₁).

Location information on the target sector (S₁₁) where a refresh operation is performed is stored in the refresh register 436. For example, the control logic 436 controls the nonvolatile memory device 430 to store location information on the sector (S₁₁) where a refresh operation is performed in the refresh register 436.

After that, when a data writing command is provided from the host again, the control logic 437 determines location information on the sector where a refresh operation is performed, the location information being stored in the refresh register 436. The control logic 437 controls the nonvolatile memory device 430 so that a refresh operation is performed on a next sector of the sector on which a refresh operation is performed. For example, the control logic 437 controls the nonvolatile memory device 430 so that a refresh operation is performed on a next sector (S₂₁) of the sector (S₁₁) on which a refresh operation is performed.

According to the method described above, a refresh operation may be performed on sectors included in the memory cell array 431. Referring to FIG. 2, when data writing commands of m×n number of times are provided from the host 410, all the sectors of the memory cell array 431 are refreshed one time according to an order. Thus, a data retention characteristic of the memory cell array 431 may be improved.

Example embodiments of inventive concepts are not limited to the structure of the memory system 400 shown above. For example, the memory controller 420 may include the time control unit of FIG. 4. A structure of the memory controller 420 of FIG. 7 may be similar to a structure of the memory controller 220 of FIG. 4.

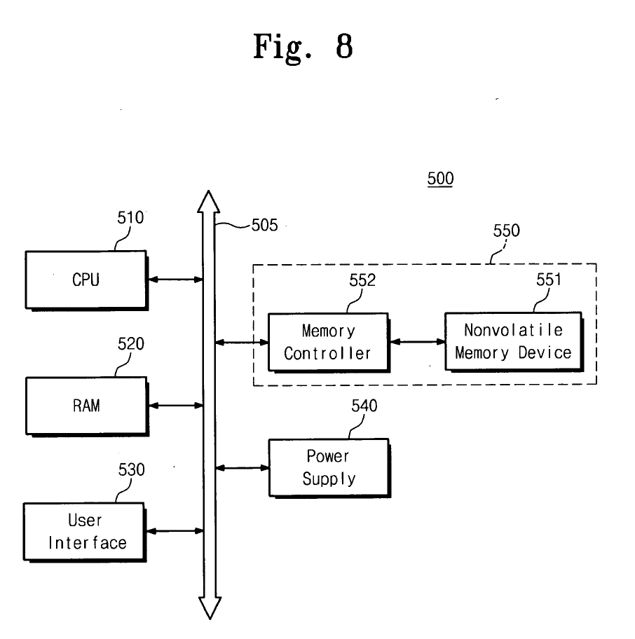

FIG. 8 is a block diagram illustrating a computing system 500 including a memory system in accordance with example embodiments of inventive concepts. Referring to FIG. 8, the computing system 500 includes a central processing unit 510, a random access memory 520 (RAM), a user interface 530, a power supply 540 and a memory system 550.

The memory system 550 is electrically connected to the central processing unit 510, the random access memory 520 (RAM), the user interface 530 and the power supply 540 through a system bus 505. Data provided through the user interface 530 or processed by the central processing unit 510 is stored in the memory system 550. The memory system 550 includes a controller 552 and a nonvolatile memory device 551. In the drawing, the nonvolatile memory device 551 is connected to the system bus 505 through the controller 552. However, in example embodiments of inventive concepts, the nonvolatile memory device 551 may also be directly connected to the system bus 505.

In the case that the memory system 550 is constituted by a solid state drive (SSD), a booting speed of the computing system 500 may be improved. Although not illustrated in the drawing, the system in accordance with example embodiments of inventive concepts may further include an application chipset, a camera image processor and so on.

The memory system in accordance with example embodiments of inventive concepts performs a refresh operation whenever a writing command is provided from the host. Thus, reliability of data stored in the memory cell array may be improved.

The above-disclosed subject matter is to be considered illustrative, and not restrictive, and the appended claims are intended to cover all such modifications, enhancements, and other embodiments, which fall within the true spirit and scope of example embodiments of inventive concepts. Thus, to the maximum extent allowed by law, the scope of example embodiments of inventive concepts is to be determined by the broadest permissible interpretation of the following claims and their equivalents, and shall not be restricted or limited by the foregoing detailed description.

What is claimed is:

1. A memory system comprising:
a memory cell array including a plurality of memory sectors; and
a controller configured to write data in the memory cell array in response to a writing signal, wherein
the controller is configured to refresh at least one of the plurality memory sectors when the writing signal is provided.

2. The memory system of claim 1, further comprising:
a refresh memory configured to temporarily store data of a target sector of the plurality of memory sectors in response to the writing signal, wherein
the target sector is at least one of memory sectors being refreshed.

3. The memory system of claim 2, wherein, in response to the writing signal, the controller is configured to,
read data in the target sector,
store the data read from the target sector to the refresh memory, and
write the data stored in the refresh memory back to the target sector in order to refresh the target sector.

4. The memory system of claim 3, further comprising:
a refresh register configured to store location information on the refreshed memory sector.

5. The memory system of claim 4, wherein the controller is configured to update the location information of the refresh register when the target sector is refreshed.

6. The memory system of claim 5, wherein the controller is configured to check the refresh register and configured to determine a next target sector to be refreshed according to the location information stored in the refresh register.

7. The memory system of claim 1, wherein the controller is configured to refresh the plurality of memory sectors according to a reprogram method.

8. The memory system of claim 1, wherein the controller is configured to refresh the memory sectors according to a type of order.

9. The memory system of claim 1, wherein the controller is configured to refresh the memory sectors sequentially.

10. The memory system of claim 1, further comprising:
a time control unit configured to store a present time when the memory system powers up.

11. The memory system of claim 10, wherein the time control unit is further configured to store a refresh cycle completion time indicating that a refresh operation is completed on all of the plurality of memory sectors of the memory cell array.

12. The memory system of claim 11, wherein a refresh operation is performed on all the memory sectors of the memory cell array if a difference between the present time and the refresh completion time is greater than a reference time.

13. The memory system of claim 12, wherein the reference time is shorter than a guarantee time of the memory cell array, where the guarantee time corresponds to a time that a data retention characteristic of the memory cell array is not changed by a disturbance.

14. The memory system of claim 12, wherein a duration of the reference time is inversely proportional to the number of the memory sectors.

15. The memory system of claim 1, wherein each of the memory sectors includes a plurality of memory cells configured to store the data.

16. The memory system of claim 15, wherein a number of the plurality of memory sectors is set up according to a durability of the plurality of memory cells with respect to at least one of read and write operations.

17. The memory system of claim 15, wherein a number of the plurality of memory sectors is set up according a guarantee time of the plurality of memory cells, where the guarantee time corresponds to a time that a data retention characteristic of the plurality of memory cells is not changed by a disturbance.

18. The memory system of claim 15, wherein the plurality of memory cells include a plurality of phase change memory cells (PRAM).

19. The memory system of claim 15, wherein the plurality of memory cells include a plurality of magnetroresistive random access memory (MRAM) cells.
